(19) United States
(12) Patent Application Publication
(10) Pub. No.: US 2019/0178545 A1
(43) Pub. Date: Jun. 13, 2019

(54) HEATING, VENTILATING, AIR CONDITIONING, AND REFRIGERATION SYSTEM WITH MASS FLOW STABILIZATION

(71) Applicant: DunAn Microstaq, Inc., Austin, TX (US)

(72) Inventors: Dhaman K. Besarla, Leander, TX (US); Colin B. Bingle, Austin, TX (US); Kevin C. Sinkar, Austin, TX (US); Eric S. Shea, Austin, TX (US)

(73) Assignee: DunAn Microstaq, Inc., Austin, TX (US)

(21) Appl. No.: 16/050,007

(22) Filed: Jul. 31, 2018

Related U.S. Application Data
(60) Provisional application No. 62/595,752, filed on Dec. 7, 2017.

(51) Int. Cl. F25B 49/02; F25B 41/06

(52) U.S. Cl. CPC F25B 49/02; G01K 2013/026; F25B 41/062

(57) ABSTRACT

A heating, ventilating, air conditioning, and refrigeration (HVAC-R) system includes an evaporator, a compressor, a condenser, an expansion device between the condenser and the evaporator, a superheat controller between the evaporator and the compressor, and a mass flow meter between the condenser and the expansion device. The superheat controller is configured to measure refrigerant fluid pressure and temperature and calculate superheat therefrom, to receive and analyze a mass flow rate of the refrigerant fluid traveling out of the condenser and measured by the mass flow meter, and further configured to provide a control signal to the expansion device.

### BACKGROUND OF THE INVENTION

This invention relates in general to heating, ventilating, air conditioning, and refrigeration (HVAC-R) systems. In particular, this invention relates to an improved HVAC-R system structure and an improved method of controlling an expansion valve in an HVAC-R system to achieve improved cooing of an evaporator.

In a conventional HVAC-R system, an expansion valve is controlled based on the superheat. Superheat control is achieved using pressure sensor and a temperature sensor to measure HVAC-R system fluid pressure and temperature, respectively. Superheat is then calculated for a particular refrigerant using the measured temperature and pressure, and controlled by causing the superheat to move to a target superheat value by adjusting the pressure and temperature using any of a group of known open-loop or closed-loop algorithms.

Superheat is a function of pressure and temperature, and is conventionally calculated using pressure-temperature (P-T) charts that map a saturation temperature at a particular pressure. The values of the saturation temperatures at particular pressures may vary with different refrigerants. These values for saturation temperature and a temperature of the refrigerant are typically measured at an outlet of an evaporator in the conventional HVAC-R system, and are typically used to calculate superheat.

Typical HVAC-R systems in which a refrigerant fluid mass flow rate exiting the condenser is relatively stable tend to be more efficient than similar HVAC-R systems in which the refrigerant fluid mass flow rate exiting the condenser is unstable.

Thus, it would be desirable to provide an improved HVAC-R system structure and an improved method of controlling the expansion valve by stabilizing the refrigerant fluid mass flow rate exiting the condenser and then controlling the superheat at the outlet of the evaporator.

### SUMMARY OF THE INVENTION

This invention relates to an improved structure and an improved method of controlling the expansion valve in an HVAC-R system.

In one embodiment the heating, ventilating, air conditioning, and refrigeration (HVAC-R) system includes an evaporator, a compressor, a condenser, an expansion device between the condenser and the evaporator, a superheat controller between the evaporator and the compressor, and a mass flow meter between the condenser and the expansion device. The superheat controller is configured to measure refrigerant fluid pressure and temperature and calculate superheat therefrom, to receive and analyze a mass flow rate of the refrigerant fluid traveling out of the condenser and measured by the mass flow meter, and further configured to provide a control signal to the expansion device.

Various aspects of this invention will become apparent to those skilled in the art from the following detailed description of the preferred embodiment, when read in light of the accompanying drawings.

### BRIEF DESCRIPTION OF THE DRAWINGS

FIG. 1 a block diagram of a first embodiment of an HVAC-R system according to the invention.

FIG. 2 is a block diagram of a second embodiment of an HVAC-R system according to the invention.

FIG. 3 is a perspective view of the universal superheat controller illustrated in FIGS. 1 and 2.

FIG. 4 is a cross sectional view of the universal superheat controller illustrated in FIG. 3.

### DETAILED DESCRIPTION OF THE PREFERRED EMBODIMENT

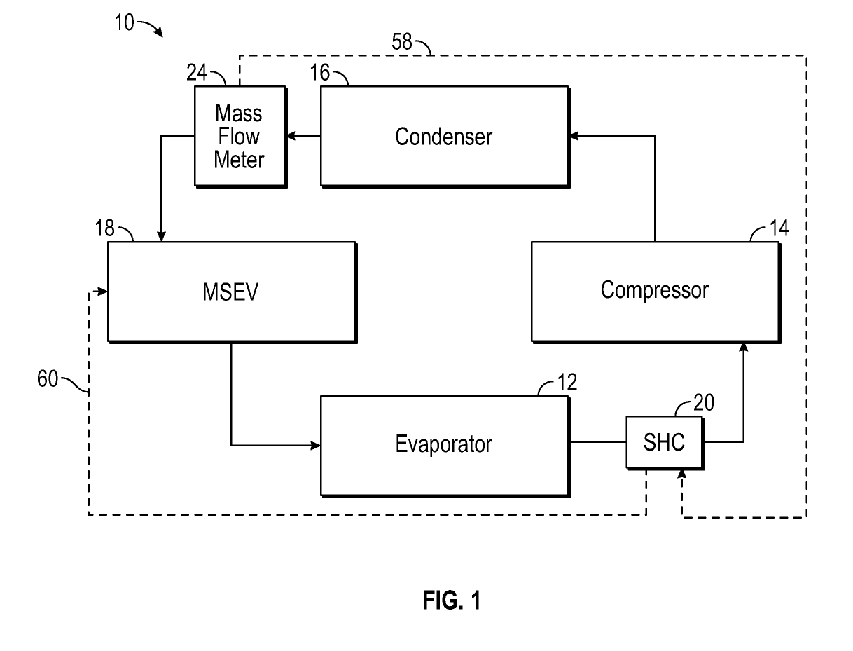

Referring now to FIG. 1, there is illustrated at 10 a block diagram of a first embodiment of a HVAC-R system in accordance with this invention. Other than an improved superheat processor 22 of a superheat controller 20 and a mass flow meter 24, the illustrated HVAC-R system 10 is, in large measure, conventional in the art and is intended merely to illustrate one environment in which this invention may be used. Thus, the scope of this invention is not intended to be limited for use with the specific structure for the HVAC-R system 10 illustrated in FIG. 1 or with refrigeration systems in general. On the contrary, as will become apparent below, this invention may be used in any desired environment for the purposes described below.

As is well known in the art, the HVAC-R system 10 circulates a refrigerant through a closed circuit, where it is sequentially subjected to compression, condensation, expansion, and evaporation. The circulating refrigerant removes heat from one area (thereby cooling that area) and expels the heat in another area.

To accomplish this, the illustrated HVAC-R system 10 includes an evaporator 12, such as an evaporator coil. The evaporator 12 may be conventional in the art and is adapted to receive a relatively low pressure liquid refrigerant at an inlet thereof. A relatively warm fluid, such as air, may be caused to flow over the evaporator 12, causing the relatively low pressure liquid refrigerant flowing in the evaporator 12 to expand, absorb heat from the refrigerant fluid flowing over the evaporator 12, and evaporate within the evaporator 12. The relatively low pressure liquid refrigerant entering into the inlet of the evaporator 12 is thus changed to a relatively low pressure refrigerant gas exiting from an outlet of the evaporator 12.

The outlet of the evaporator 12 communicates with an inlet of a compressor 14. The compressor 14 may be conventional in the art and is adapted to compress the relatively low pressure refrigerant gas exiting from the evaporator 12 and to move such relatively low pressure refrigerant gas through the HVAC-R system 10 at a relatively high pressure. The relatively high pressure refrigerant gas is discharged from an outlet of the compressor 14 that communicates with an inlet of a condenser 16. The condenser 16 may be conventional in the art and is configured to remove heat from the relatively high pressure refrigerant gas as it passes therethrough. As a result, the relatively high pressure refrigerant gas condenses and becomes a relatively high pressure refrigerant liquid.

The relatively high pressure refrigerant liquid then moves from an outlet of the condenser 16 to an inlet of an expansion device or valve. In the illustrated embodiment, the expansion device is a Modular Silicon Expansion Valve (MSEV) 18, described below, that is configured to restrict the flow of refrigerant fluid therethrough. As a result, the relatively high pressure refrigerant liquid is changed to a relatively low pressure refrigerant liquid as it leaves the expansion device. The relatively low pressure refrigerant liquid is then returned to the inlet of the evaporator 12, and the refrigeration cycle is repeated.

The illustrated embodiment of the HVAC-R system 10 additionally includes at least one external sensor, configured as a superheat controller (SHC) 20, described below, and that communicates with the fluid line that provides fluid communication from the evaporator 12 to the compressor 14. The illustrated embodiment of the HVAC-R system 10 also includes the mass flow meter 24. The mass flow meter 24 may be conventional in the art and configured to measure the mass flow rate (the mass per unit time, e.g., kilograms per second) of refrigerant fluid traveling through the condenser 16, and specifically measured at the outlet of the condenser 16. The mass flow meter 24 reports mass flow rate data to the SHC 20 through a wire or cable 58. Alternatively, the mass flow meter 24 may be connected to the SHC 20 by a wireless connection.

The SHC 20 is responsive to one or more properties of the refrigerant fluid in the fluid line (such as, for example, pressure measured by a pressure sensor portion 42, and temperature measured by a temperature sensor portion 44, both described below) and generates a signal that is representative of that or those properties to a controller or processor, such as a superheat processor 22 within the SHC 20, also described below. In response to the signal from the SHC 20 (and, if desired, a target device 56 described below, and other non-illustrated sensors or other inputs), the superheat processor 22 generates a signal to control the operation of the MSEV 18 via a wire or cable 60. Alternatively, the SHC 20 may be connected to the MSEV 18 by a wireless connection.

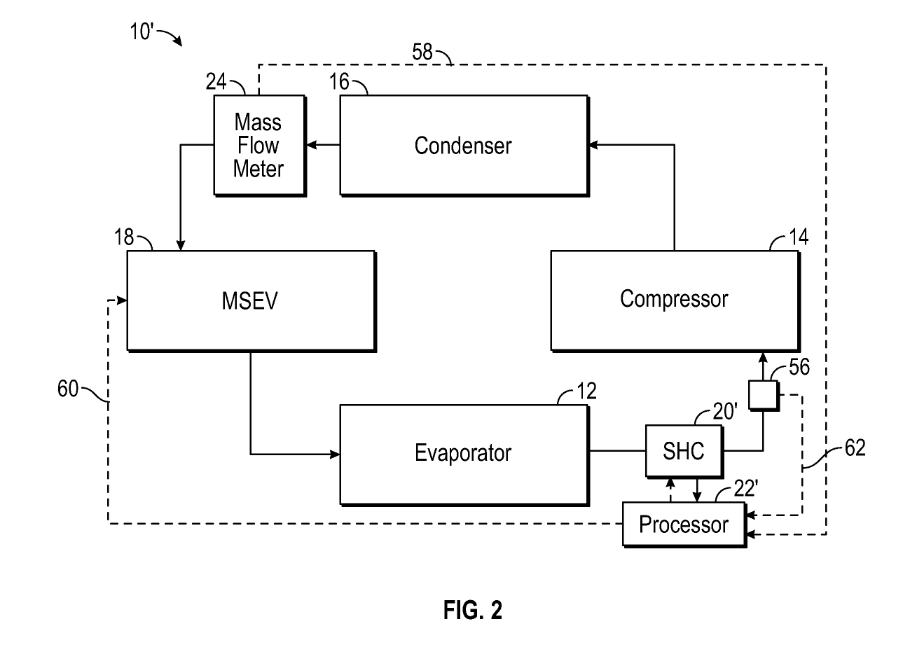

A second embodiment of the HVAC-R system in accordance with this invention is shown at 10′ in FIG. 2 and includes a second embodiment of the SHC 20′. As shown in FIG. 2, the superheat processor 22′ may be mounted to the HVAC-R system 10′ external of the SHC 20′. The superheat processor 22′ is substantially identical to the superheat processor 22, and will not be further described herein. The second embodiment of the HVAC-R system 10′ also includes the target device 56 configured as a temperature sensor and connected to the superheat processor 22, 22′ via a wire or cable 62. Alternatively, the target device 56 may be connected to the superheat processor 22, 22′ by a wireless connection. The target device 56 that may also be configured as a plurality of temperature sensors, laptop and notebook computers, cell phones, memory cards, and any device or devices used in or with conventional end of the line test equipment.

MSEVs, such as the MSEV 18, are electronically controlled, normally closed, and single flow directional valves, and may be used for refrigerant fluid mass flow control in conventional HVAC and HVAC-R applications.

The exemplary MSEV 18 illustrated in FIGS. 1 and 2, is a two-stage proportional control valve. The first stage is a microvalve (not shown) configured as a pilot valve to control a second stage spool valve (not shown). When the microvalve (not shown) receives a Pulse Width Modulation (PWM) signal from the superheat processor 22, 22′, the microvalve (not shown) modulates to change the pressure differential across the second stage spool valve (not shown). The spool valve (not shown) will move to balance the pressure differential, effectively changing an orifice opening of the MSEV 18 to control a desired amount of refrigerant flow.

U.S. Pat. No. 9,140,613 discloses a superheat controller (SHC). The SHC disclosed therein is a single, self-contained, stand-alone device which contains all the sensors, electronics, and intelligence to automatically detect a fluid type, such as refrigerant, and report the superheat of multiple common fluid types used in residential, industrial, and scientific applications. U.S. Pat. No. 9,140,613 is incorporated herein in its entirety.

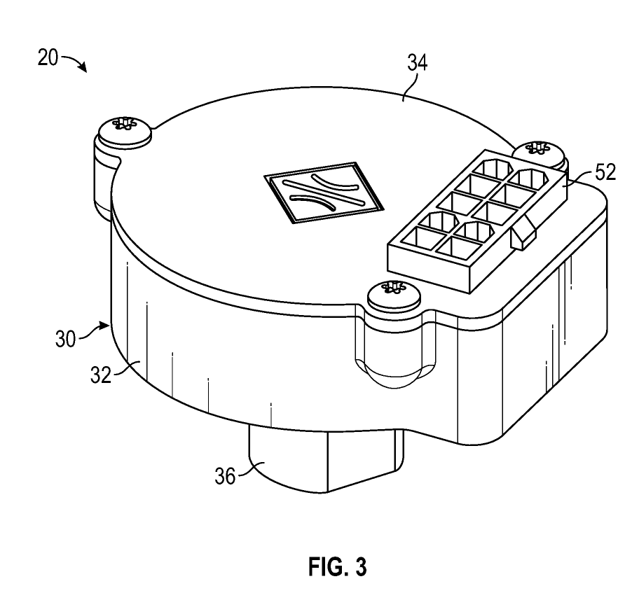

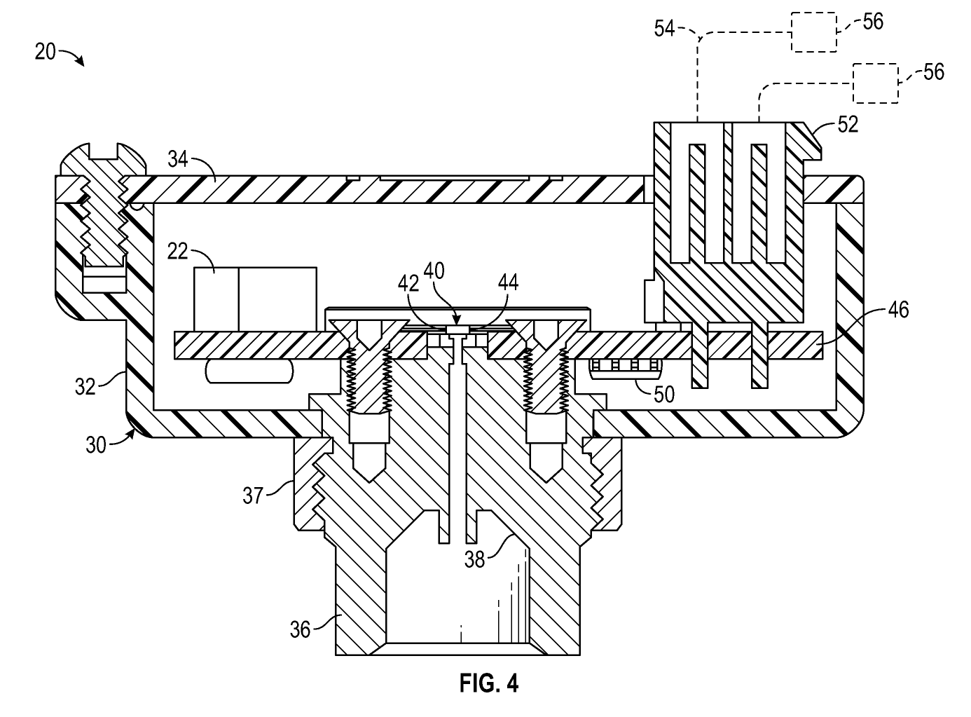

FIGS. 3 and 4 herein illustrate the SHC 20, which is similar to the superheat controller disclosed in U.S. Pat. No. 9,140,613. The SHC 20, like the HVAC-R system 10 described above, is in large measure, conventional in the art, and is intended merely to illustrate one device in which this invention may be used. Thus, the scope of this invention is not intended to be limited for use with the specific structure for the SHC 20 illustrated in FIGS. 3 and 4 or with devices configured to detect and report superheat in a fluid system in general. On the contrary, as will become apparent below, this invention may be used in any desired device for the purposes described below.

As shown in FIGS. 3 and 4, the illustrated embodiment of the SHC 20 includes a housing 30 having a body 32, a cover 34, and a fluid inlet member 36. The fluid inlet member 36 may be secured to the housing 30 by a mounting ring 37. The mounting ring 37 attaches the fluid inlet member 36 to the housing 30 portion by a threaded connection. Alternatively, the mounting ring 37 may be attached to the fluid inlet member 36 by any desired method, such as by welding or press fitting. In the embodiment illustrated in FIGS. 3 and 4, the fluid inlet member 36 is a brass fitting having a centrally formed opening that defines a sealing surface 38.

The SHC 20 includes an integrated pressure and temperature sensor 40 having pressure sensor portion 42 and a temperature sensor portion 44 mounted to a printed circuit board (PCB) 46. The superheat processor 22, a data-reporting or communication module 50, and an Input/Output (IO) module 52 are also mounted to the PCB 46. The IO module 52 is a physical hardware interface that accepts input power and reports data through available hard-wired interfaces, such as wires or cables 54, to the superheat processor 22. Target devices 56 that may be connected to the SHC 20 via the IO module 52 may include additional temperature sensors, laptop and notebook computers, cell phones, memory cards, and any device used in or with conventional end of the line test equipment. Alternatively, the target devices 56 may be connected to the communication module 50 by a wireless connection.

The superheat processor 22 is mounted to the PCB 46 and is a high-resolution, high-accuracy device that processes the input signals from the pressure and temperature sensor portions 42 and 44, respectively, of the integrated pressure and temperature sensor 40, detects the fluid type, calculates the superheat of the fluid, and provides an output that identifies the level of the calculated superheat. The superheat processor 22 may also be configured to provide other data, such as fluid temperature, fluid pressure, fluid type, relevant historical dates maintained in an onboard memory (such as alarm and on-off history), and other desired information. Advantageously, the superheat processor 22 maintains a high level of accuracy over a typical operating range of pressure and temperature after a one-time calibration. Non-limiting examples of suitable superheat processors include microcontrollers, Field Programmable Gate Arrays (FPGAs), and Application Specific Integrated Circuits (ASICs) with embedded and/or off-board memory and peripherals.

The mass flow rate of refrigerant fluid traveling out of the condenser 16 is measured by the mass flow meter 24 and provided to the superheat processor 22, 22′. Advantageously, the mass flow rate may be combined with pressure and temperature data from the pressure sensor portion 42 and the temperature sensor portion 44, respectively, as feedback inputs to control the expansion valve, i.e., the MSEV 18, of the HVAC-R system 10. With the mass flow rate provided by the mass flow meter 24, a control signal provided to the MSEV 18 by the superheat processor 22, 22′ may be weighted so as to maintain a stable or consistent fluid mass flow rate into the evaporator 12. The improved HVAC-R system 10 may be especially useful in fluid systems that experience only small load changes over time, such as for example, closed door refrigerated display cases in grocery stores and the like.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A heating, ventilating, air conditioning, and refrigeration (HVAC-R) system comprising:
an evaporator;
a compressor;
a condenser;
an expansion device between the condenser and the evaporator;
a superheat controller between the evaporator and the compressor; and
a mass flow meter between the condenser and the expansion device;
wherein the superheat controller is configured to measure refrigerant fluid pressure and temperature and calculate superheat therefrom, to receive and analyze a mass flow rate of the refrigerant fluid traveling out of the condenser and measured by the mass flow meter, and further configured to provide a control signal to the expansion device.

2. The HVAC-R system according to claim 1, wherein the control signal from the superheat controller to the expansion device is configured to ensure a stable mass flow rate of the refrigerant fluid traveling into the evaporator.

3. The HVAC-R system according to claim 1, wherein the expansion valve is a modular silicon expansion valve.

4. The HVAC-R system according to claim 3, wherein the modular silicon expansion valve is a two-stage proportional control valve, wherein a first stage is a microvalve configured as a pilot valve to control a second stage spool valve, wherein when the microvalve receives a Pulse Width Modulation (PWM) signal from a superheat processor operatively connected to the superheat controller, the microvalve modulates to change a pressure differential across the second stage spool valve, and wherein the spool valve will move to balance the pressure differential, changing an orifice opening of the modular silicon expansion valve to control a desired amount of refrigerant flow.

5. The HVAC-R system according to claim 1, wherein the superheat controller includes an integrated superheat processor.

6. The HVAC-R system according to claim 5, wherein the superheat controller includes an integrated pressure sensor.

7. The HVAC-R system according to claim 6, wherein the superheat controller includes an integrated temperature sensor.

8. The HVAC-R system according to claim 1, further including a superheat processor external to the superheat controller and electrically connected thereto.

9. The HVAC-R system according to claim 1, further including one of a temperature sensor, a computer, a cell phone, and a memory card, mounted external to the superheat controller and electrically connected thereto.

10. A method of controlling fluid flow through a heating, ventilating, air conditioning, and refrigeration (HVAC-R) system comprising:
measuring temperature and pressure at an outlet of an evaporator of the HVAC-R system, wherein the evaporator is in fluid communication with a compressor, a condenser, and an expansion device;
sending the measured temperature and pressure data to a superheat processor;
calculating superheat within the superheat processor;
measuring a mass flow rate of refrigerant fluid traveling out of the condenser;
sending the measured mass flow rate data to the superheat processor; and
sending a control signal to the expansion device.

11. The method according to claim 10, wherein the control signal from the superheat processor to the expansion device is configured to ensure a stable mass flow rate of the refrigerant fluid traveling into the evaporator.

12. The method according to claim 10, wherein the step of sending a control signal to the expansion device includes combining the measured mass flow rate data with the measured temperature and pressure data within the superheat processor.

13. The method according to claim 10, wherein the expansion valve is a modular silicon expansion valve.

14. The method according to claim 13, wherein the modular silicon expansion valve is a two-stage proportional control valve, wherein a first stage is a microvalve configured as a pilot valve to control a second stage spool valve, wherein when the microvalve receives a Pulse Width Modulation (PWM) signal from a superheat processor operatively connected to the superheat controller, the microvalve modulates to change a pressure differential across the second stage spool valve, and wherein the spool valve will move to balance the pressure differential, changing an orifice opening of the modular silicon expansion valve to control a desired amount of refrigerant flow.

15. The method according to claim 10, wherein the superheat processor is an integrated component of a superheat controller and electrically connected to the superheat controller.

16. The method according to claim 15, wherein the superheat controller includes an integrated pressure sensor.

17. The method according to claim 16, wherein the superheat controller includes an integrated temperature sensor.

18. The method according to claim 17, wherein including one of a temperature sensor, a computer, a cell phone, and a memory card, mounted external to the superheat controller and electrically connected thereto.

19. The method according to claim 18, further including the step of sending data from the one of a temperature sensor, a computer, a cell phone, and a memory card to the superheat processor.
